(19) United States
(12) Patent Application Publication
(10) Pub. No.: US 2017/0036476 A1
(43) Pub. Date: Feb. 9, 2017

(54) PAGE-LIFTING REDUCTION DEVICE, PAGE-TURNING APPARATUS, AND METHOD OF TURNING PAGE

(71) Applicant: CASIO COMPUTER CO., LTD., Tokyo (JP)

(72) Inventor: Naoto IMAMURA, Tokyo (JP)

(73) Assignee: CASIO COMPUTER CO., LTD., Tokyo (JP)

(21) Appl. No.: 15/173,480

(22) Filed: Jun. 3, 2016

(30) Foreign Application Priority Data
Aug. 4, 2015 (JP) 2015-153975

(51) Int. Cl. B42D 9/06

(52) U.S. Cl. CPC B42D 9/06

(57) ABSTRACT

A page-turning apparatus includes a page-lifting reduction device for reducing lifting of each of pages P of a book B at an original position. The page-lifting reduction device includes a page fixing unit to push the pages P at the original position, and an adjusting unit to adjust the position of the page fixing unit in a thickness direction of the book B depending on a thickness of the book B. The page fixing unit includes a page handling portion to handle the pages P in an overlapped state while the pages P are being pushed at the original position. The page-lifting reduction device prevents the pages from being turned in an overlapped state at once.

### CROSS REFERENCE TO RELATED APPLICATION

This application is based upon and claims the benefit of priority under 35 USC 119 of Japanese Patent Application No. 2015-153975 filed on Aug. 4, 2015, the entire disclosure of which, including the description, claims, drawings and abstract, is incorporated herein by reference in its entirety.

### BACKGROUND OF THE INVENTION

1. Field of the Invention

The present invention relates to a page-lifting reduction device, a page-turning apparatus, and a method of turning pages.

2. Description of the Related Art

A typical page-turning apparatus includes a sucking mechanism which sucks each page of stacked pages of, for example, a book, to lift and turn the pages one by one (see, for example, Japanese Unexamined Patent Application Publication No. H06-48067).

Such a page-turning apparatus may fail to turn the pages of a book one by one because a plurality of pages are lifted in an overlapped state due to attachment between pages or the presence of burrs formed during page cutting.

### SUMMARY OF THE INVENTION

According to a first aspect of the present invention, there is provided a page-lifting reduction device for reducing lifting of each of pages of an opened book, the page-lifting reduction device including: a page fixing unit that pushes the pages; and an adjusting unit that adjusts a position of the page fixing unit in a thickness direction of the book depending on a thickness of the book, wherein the page fixing unit comprises a page handling portion to handle the pages while the pages are being pushed.

According to a second aspect of the present invention, there is provided a page-lifting reduction device including: a contact member that includes a first region which comes into contact with a page of an opened book and a second region which comes into contact with a side of the opened book; and a pressing unit that causes the contact member to press the page and subsequent pages in a thickness direction of the opened book, wherein the second region has a shape such that an edge of an upper page of the opened book is more displaced compared to a lower page toward a seam of the book, provided that an opened page is defined as an uppermost page.

According to a third aspect of the present invention, there is provided a page-turning apparatus for turning each of pages of an opened book, the page-turning apparatus causing a predetermined unit to be brought into contact with a page of the opened book at an original position and to release the page from the predetermined unit at a turned position, the page following the predetermined unit to the turned position, the page-turning apparatus including: a support base that supports the opened book; and the page-lifting reduction device according to the first aspect.

According to a fourth aspect of the present invention, there is provided a method of turning each of pages of an opened book, including: handling the pages while pushing the pages with a page fixing unit which includes a curved or inclined page handling surface at an original position; causing a predetermined unit to be brought into contact with an upper page of the opened book at the original position; and releasing the page from the predetermined unit at a turned position, the page following the predetermined unit to the turned position due to the contact.

### BRIEF DESCRIPTION OF THE DRAWINGS

The present invention will become more fully understood from the detailed description given hereinafter and the appended drawings, which are given by way of illustration only and thus are not intended as a definition of the limit of the present invention, wherein:

FIG. 1 is a perspective view of the outline configuration of a page-turning apparatus;

FIG. 2A is a perspective view seen from the left diagonal front showing a page-lifting reduction device and FIG. 2B is a perspective view seen from the right diagonal rear showing the page-lifting reduction device;

FIG. 3A is a perspective view seen from the left diagonal front showing the page-lifting reduction device when a page fixing unit is located at the uppermost position, and FIG. 3B is a perspective view seen from the right diagonal rear showing the page-lifting reduction device when the page fixing unit is located at the uppermost position;

FIGS. 4A and 4B are a perspective views each showing a page-lifting reduction device according to another embodiment, and a FIG. 4A is a perspective view seen from the left diagonal front showing the page-lifting reduction device and FIG. 4B is a perspective view seen from the right diagonal rear showing the page-lifting reduction device;

FIG. 5A is a schematic perspective view of the configuration of a page fixing unit according to an embodiment of the present invention, and FIGS. 5B and 5C are perspective views of page fixing units according to other embodiments;

FIG. 6 is a front view showing one operation state of the page-turning apparatus;

FIG. 7 is a front view showing another operation state of the page-turning apparatus; and

FIG. 8A and FIG. 8B are views each showing a page-lifting reduction device according to another embodiment, and FIG. 8A is a schematic perspective view of the configuration of the page-lifting reduction device, and FIG. 8B is a cross-sectional view taken along line A-A of FIG. 8A.

### DETAILED DESCRIPTION OF THE PREFERRED EMBODIMENT

An embodiment of the present invention will now be described with reference to the accompanying drawings. Although the embodiment will be described with various technically preferred limitations, the scope of the present invention should not be limited to the embodiments and the drawings.

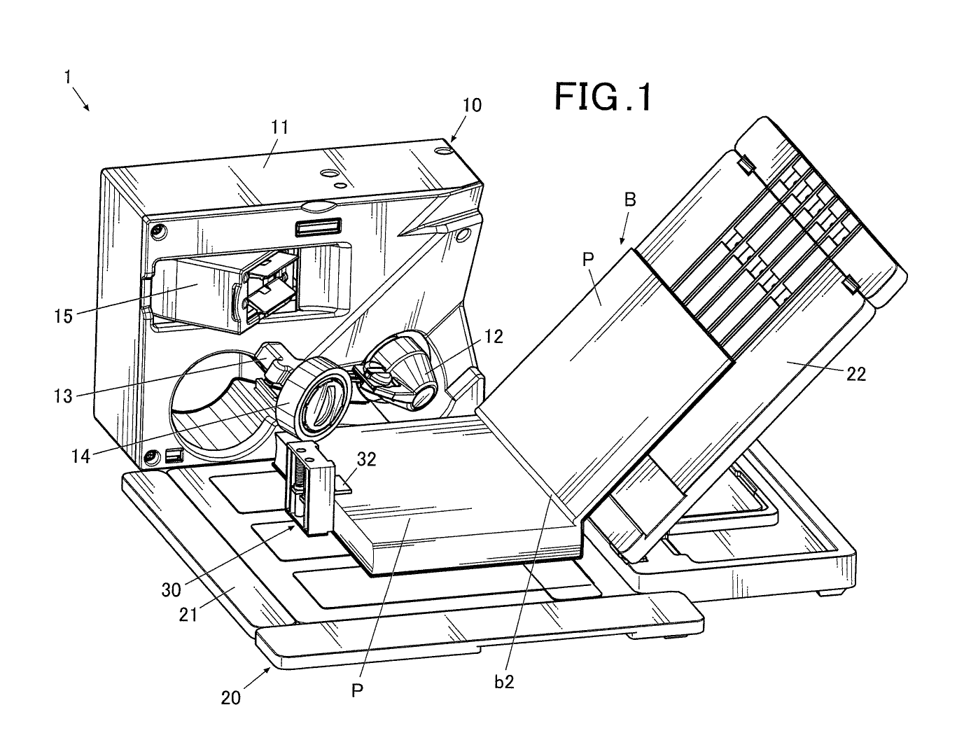

FIG. 1 is a schematic perspective view of the configuration of a page-turning apparatus 1 according to the present embodiment. In the following description, pages P of a book B are turned from left to right.

As shown in FIG. 1, the page-turning apparatus 1 includes a support base 20 which supports an opened book B, a turner body 10 which holds a page P of the book B on the support base 20 at an original position and releases the pushing of the page P at a turned position and a page-lifting reduction device 30 which prevents the page P at the original position from lifting or warping.

The turner body 10 includes a substantially rectangular parallelepiped casing 11; a drive 12 (e.g., a motor) having a drive shaft (not shown); an arm 13 which swings about the drive shaft; an attaching unit 14 which is disposed at the tip of the arm 13 and sucks pages P of the book B; a mount (not shown) which supports the drive 12, the arm 13, and the attaching unit 14; a blower 15 which blows air through a region above the pages P at the original position onto the pages P at the turned position; and a controller (not shown) which controls these components.

The drive shaft of the turner body 10 is inclined toward the book B. The rotation of the drive shaft causes the reciprocal swinging of the arm 13 about the drive shaft between the original and turned positions of the pages P such that the arm 13 draws a circular arc around the drive shaft.

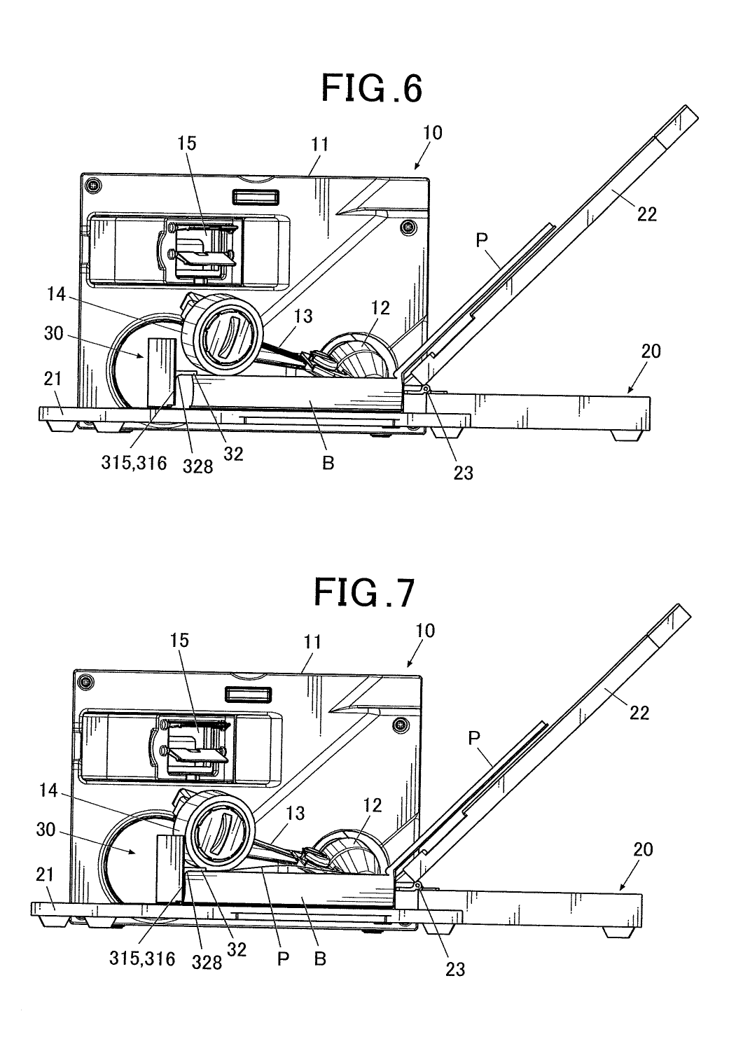

The support base 20 includes a first support plate 21 and a second support plate 22. The angle of inclination of the second support plate 22 can be adjusted with a hinge 23 (see FIG. 6). The first support plate 21 and the second support plate 22 are each composed of a magnetic material, and can support the page-lifting reduction device 30 having a magnetic sheet (attachment member 35) on the bottom face of the reducer 30. Provided that pages P of the book B are turned from left to right, the first support plate 21, which is disposed at the left, is placed on the desk, and the second support plate 22, which is disposed at the right, is raised and inclined at a predetermined angle from the first support plate 21. The pages P of the book B at the original position are placed on the first support plate 21, and the pages P of the book B at the turned position are placed on the second support plate 22.

Thus, the support base 20 supports the book B such that the pages P at the turned position are raised and inclined about a seam b2 of the book B from the pages P at the original position. The pages P at the turned position are preferably inclined at 30 to 45° from the horizontal plane.

The page-lifting reduction device 30 will now be described.

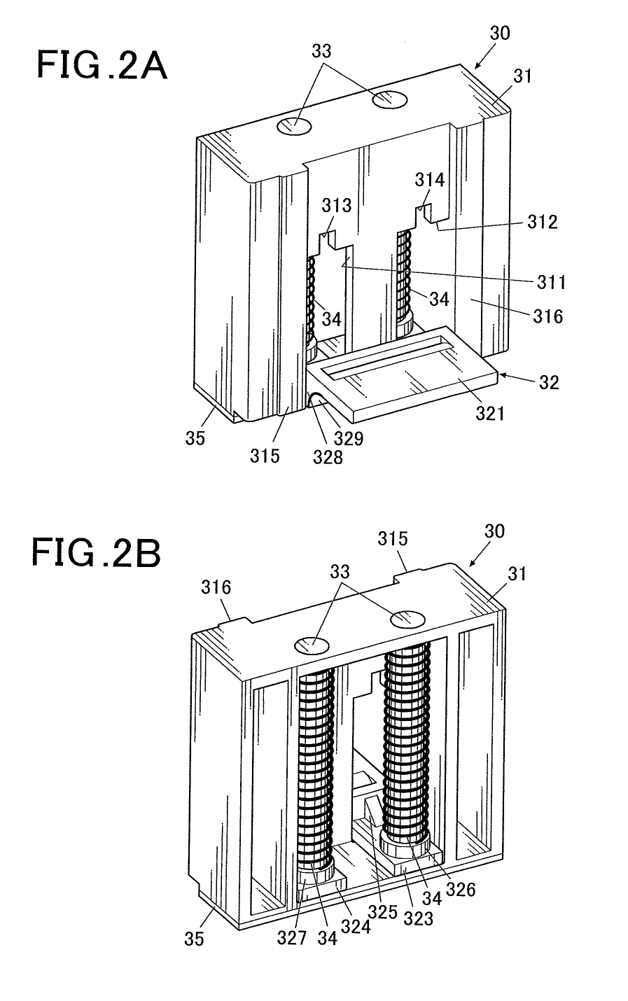

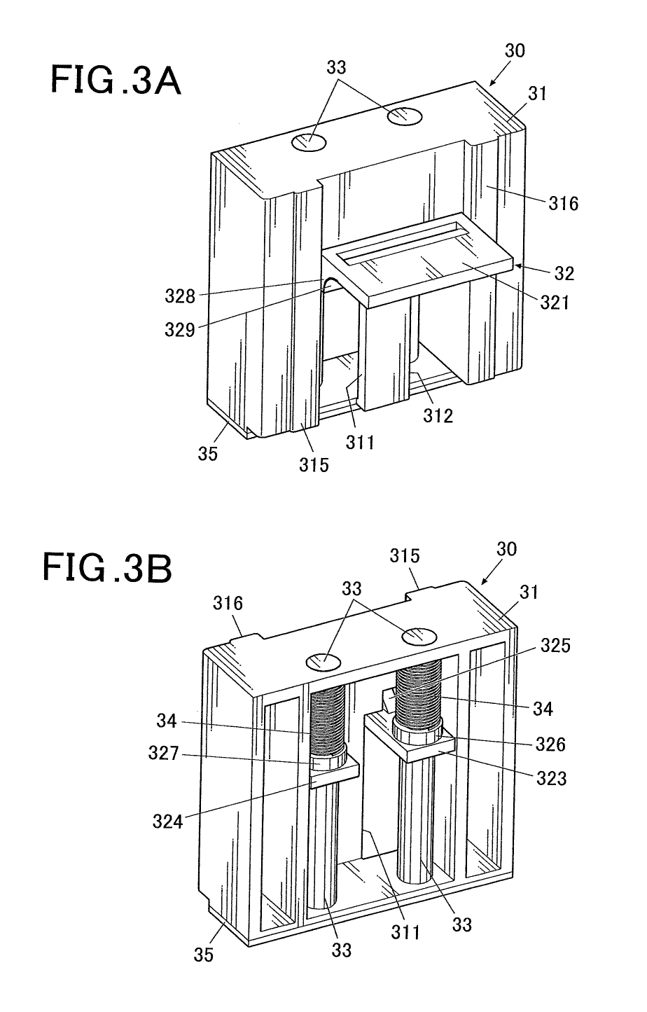

FIGS. 2A, 2B, 3A, and 3B are perspective views of the outline configuration of the page-lifting reduction device 30. FIG. 2A is a perspective view seen from the left diagonal front showing a page-lifting reduction device, and FIG. 2B is a perspective view seen from the right diagonal rear showing the page-lifting reduction device. FIG. 3A is a perspective view seen from the left diagonal front showing the page-lifting reduction device when a page fixing unit (contact member) is located at the uppermost position, and FIG. 3B is a perspective view seen from the right diagonal rear showing the page-lifting reduction device when the page fixing unit is located at the uppermost position.

As shown in FIGS. 2A and 2B, the page-lifting reduction device 30 includes a frame 31, a page fixing unit 32 which pushes pages P at the original position, two shafts 33 which slidably guide the page fixing unit 32 in the direction of pushing the pages P at the original position and in the direction of releasing the pushing of the pages P, coil springs 34 which bias the page fixing unit 32 in the direction of pushing the pages P at the original position, and an attachment member 35 for fixing the page-lifting reduction device 30 to the first support plate 21 and the second support plate 22.

The frame 31, which has a rectangular parallelepiped shape, accommodates the page fixing unit 32, the shafts 33, the coil springs 34, and the attachment member 35, and is open on the rear side.

The frame 31 has a vertically elongated left rectangular opening 311 on the front face of the frame 31. A left segment 323 (described below) in a state of protruding from the front face to the rear face of the frame 31 can move vertically through the left rectangular opening 311. The frame 31 also has a vertically elongated right rectangular opening 312 on the front face of the frame 31. A right segment 324 (described below) in a state of protruding from the front face to the rear face of the frame 31 can move vertically through the right rectangular opening 312. The left rectangular opening 311 and the right rectangular opening 312 respectively have cutouts 313 and 314 at the upper edges of the openings 311 and 312. As shown in FIG. 3A, the cutouts 313 and 314 are provided for avoiding the collision of reinforcements 325 (described below) (see FIG. 2B) with the upper edges of the left rectangular opening 311 and the right rectangular opening 312, respectively, upon movement of the page fixing unit 32 to the uppermost position (see FIG. 3B).

In the front side of the frame 31, side fixing portions 315 and 316 protruding from the front face of the frame 31 extend vertically at the left of the left rectangular opening 311 and at the right of the right rectangular opening 312, respectively. The side fixing portions 315 and 316 perform function of pushing the side, on the fore edge side, of the book placed at the original position to effectively prevent the misalignment of the book B at the original position.

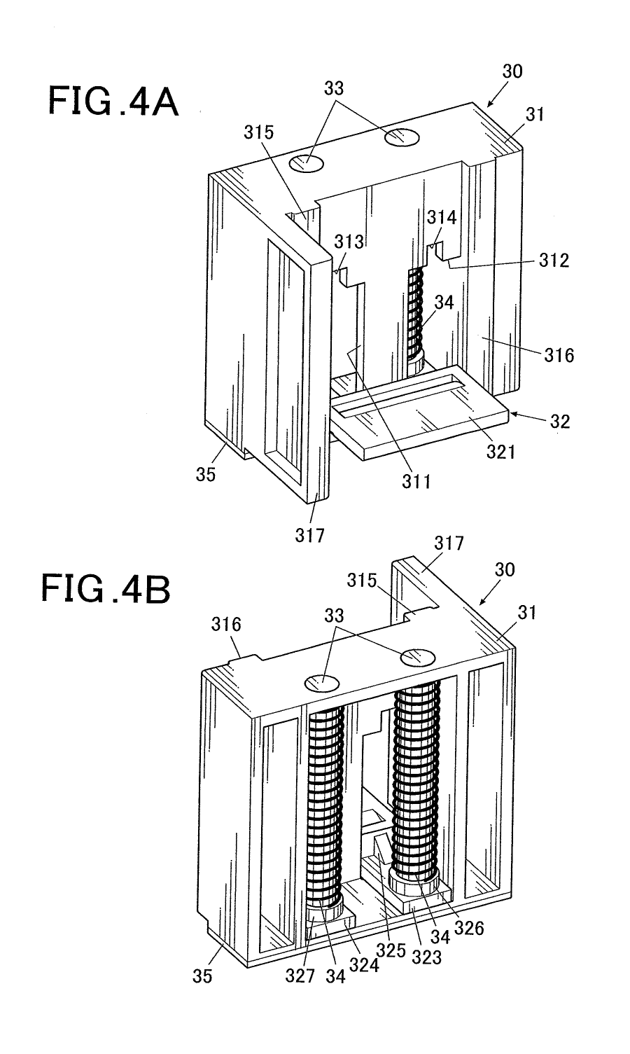

For example, as shown in FIGS. 4A and 4B, the page-lifting reduction device 30 may be provided with an extension 317 at the left end of the front face of the frame 31 so as to perform function of pushing the two portions, such as the side on the fore edge side and bottom, of the book B placed at the original position. In this case, the frame 31 has an L-shape in plan view. This configuration more effectively prevents the misalignment of the book B placed at the original position.

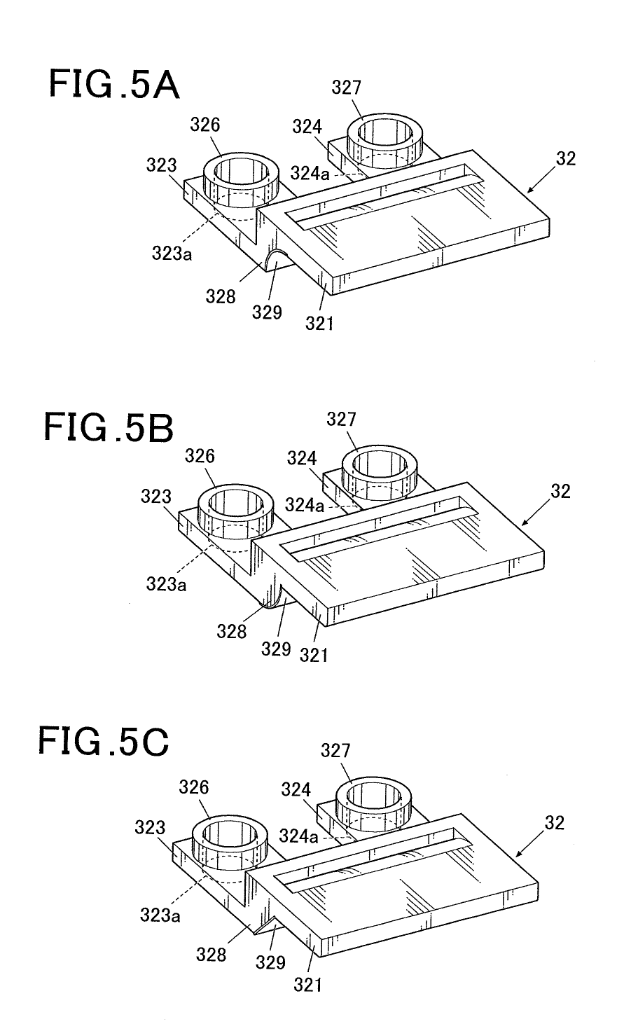

As shown in FIG. 5A, the page fixing unit 32 has a flat page pushing segment 321 which pushes pages P at the original position, a left segment 323 and a right segment 324 which extend rearward from the bottom face of the page pushing segment 321, and reinforcements 325 (see FIG. 2B) which reinforce a rear joint between the page pushing segment 321 and the left segment 323 and a rear joint between the page pushing segment 321 and the right segment 324. The page pushing segment 321 has such a size that the bottom face (first region) of the segment 321 comes into contact with a page P at the original position but does not overlap with a document region of the page P.

The left segment 323 has a disk-shaped rib 326 on the top face of the segment 323, and the left segment 323 and the rib 326 have a through hole 323a in which the left shaft 33 of the two shafts 33, 33 disposed on the frame 31 can be inserted.

The right segment 324 has a disk-shaped rib 327 on the top face of the segment 324, and the right segment 324 and the rib 327 have a through hole 324a in which the right shaft 33 of the two shafts 33, 33 disposed on the frame 31 can be inserted.

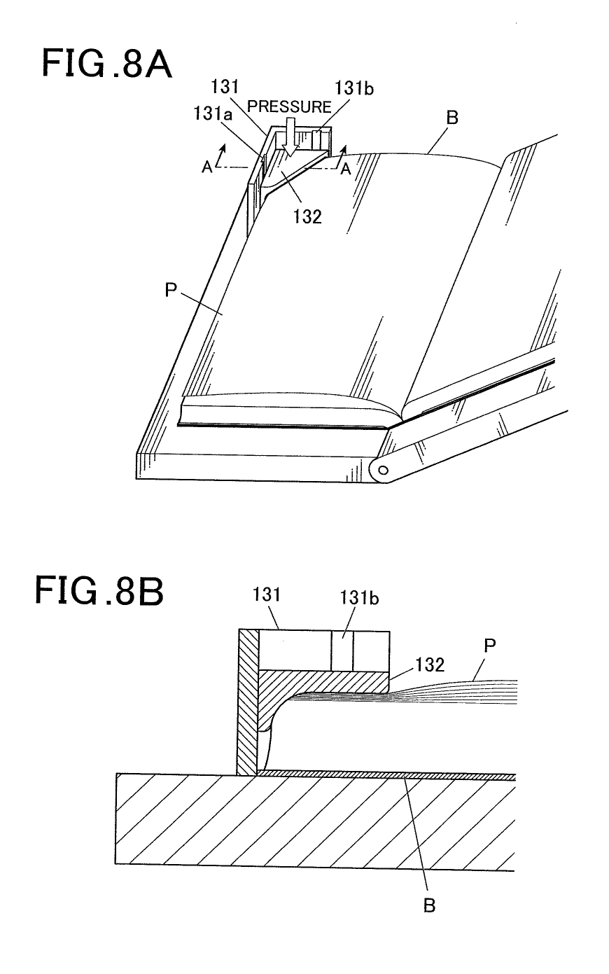

With reference to FIG. 5A, the page fixing unit 32 has a page handling portion 328 at a front joint between the page pushing segment 321 and the left segment 323. The page handling portion 328 is provided for handling a plurality of pages P in an overlapped state at the original position. The page fixing unit 32 also has a similar page handling portion (not shown) at a front joint between the page pushing segment 321 and the right segment 324. The wording “to handle a page or pages” means “to move, press or push the edges, on the fore edge side of the book, of the pages one by one toward the book seam along a shape (described below) of a front surface of the page handling portion 328 or to displace or shift the edges, on the fore edge side of the book, of the pages in a stepwise manner along the shape of the front surface of the page handling portion 328 such that the parts of the pages other than the region pressed or held down by the page fixing unit 32 and adjacent to the book seam are warped, separated each other, and not attached or adhered each other, and the page of the opened book located at a higher level is more displaced or shifted toward the book seam than the page at a lower level along the shape of the front surface of the page handling portions 328, for example, as shown in FIG. 8B”.

As shown in FIGS. 5A, 6, and 7, the page handling portion 328 has a curved (concave) front surface (i.e., a page handling surface or a second region) which comes into contact with the edge of each of the stacked pages P at the original position. The curved page handling surface displaces respectively the stacked pages P along the surface while the pages P at the original position are being pushed. Thus, the curved page handling surface plays a role similar to a thumb in displacing of pages of a book when turning the pages. The curved page handling surface can reduce attachment between pages P or prevent adhesion between the ends of pages P caused by burrs formed during page cutting.

The page handling portion 328 is provided with a friction member (e.g., a cork sheet, a urethane rubber sheet, or a synthetic leather sheet) 329 on the page handling surface for preventing slip of the pages P.

As shown in FIG. 5B, for example, the page handling portion 328 may have a convex front surface (page handling surface) which comes into contact with the edge of each of the stacked pages P at the original position. Alternatively, the page handling portion 328 may have a page handling surface inclined upward toward the front side as shown in FIG. 5C.

The shafts (adjusting units, guide members, or pressing units) 33, each of which has a cylindrical shape, are supported between the top and bottom of the frame 31 so as to be in parallel with each other.

The left shaft 33 is inserted in the coil spring 34, the rib 326, and the left segment 323 in sequence and is supported between the top and bottom of the frame 31.

The right shaft 33 is inserted in the coil spring 34, the rib 327, and the right segment 324 in sequence and is supported between the top and bottom of the frame 31.

The coil springs (adjusting units, biasing members, or pressing units) 34 bias the page fixing unit 32 in the direction of pushing of pages P at the original position. As shown in FIG. 2B, the coil springs 34 have an outer diameter substantially equal to that of the ribs 326 and 327. The coil springs 34 are disposed such that the bottoms of the springs 34 are in contact with the top faces of the ribs 326 and 327.

The attachment member 35 is a magnetic sheet for detachably fixing the page-lifting reduction device 30 to the first support plate 21 and the second support plate 22 and is disposed on the undersurface (bottom) of the page-lifting reduction device 30.

Now will be described a process of setting the page-lifting reduction device 30 on pages of an opened book B at the original position with reference to FIGS. 3A, 3B, 6, and 7.

As shown in FIGS. 3A and 3B, the page fixing unit 32 of the page-lifting reduction device 30 is lifted to the uppermost position against the biasing force by the coil springs 34. As shown in FIG. 6, the page-lifting reduction device 30 is then placed lateral to the book B placed on the first support plate 21, and pages P at the original position are pushed by the page fixing unit 32.

As shown in FIG. 7, the page-lifting reduction device 30 is then slid rightward such that the side fixing portions 315 and 316 of the page-lifting reduction device 30 come into contact with the side, on the fore edge side, of the opened book B. In this case, a plurality of upper pages P of the book B at the original position are pushed rightward in FIG. 7 and displaced each other or one by one by and along the page handling surface of the page handling portion 328. This operation prevent attachment between the pages P or prevent adhesion between the ends of the pages P caused by burrs formed during page cutting. Upon turning of the pages P at the original position, the sides, on the fore edge side of the book B, of the pages P come into contact with the page handling surface of the page handling portion 328, thereby generating a frictional force. When the pages P at the original position are turned at once, the pages other than the first page P attached to the attaching unit 14 (i.e., the second and subsequent pages P) do not slide over the page handling surface of the page handling portion 328 due to the frictional force generated at the page handling surface. Thus, the second and subsequent pages P remain at the original position without being turned.

As described above, the page-turning apparatus 1 according to the present embodiment includes the page-lifting reduction device 30 which reduces lifting or warping of pages P at the original position, and the page fixing unit 32 of the page-lifting reduction device 30 has the page handling portion 328 which handles a plurality of pages P in an overlapped state. The page-turning apparatus 1 can prevent lifting or warping of the pages P at the original position and, while the pages P are being pushed, the page-turning apparatus 1 can prevent attachment between the pages P and adhesion between the ends of the pages P caused by burrs formed during page cutting. Thus, the pages P are prevented from being turned in an overlapped state at once.

The page handling portion 328 has a curved page handling surface which comes into contact with the edges of the stacked pages P. Thus, the stacked pages P are displaced along the page handling surface while the pages P are being pushed at the original position. This curved page handling surface can reduce attachment between the pages P or prevent adhesion between the ends of the pages P caused by burrs formed during page cutting.

The page handling surface of the page handling portion 328 has the friction member 329 for preventing slip of the pages P. Even in the case of attachment between the pages P or adhesion between the ends of the pages P caused by burrs formed during page cutting, the friction member 329 allows only the first page P to be turned; i.e., the frictional force generated by the friction member 329 prevents turning of the second and subsequent pages P together with the first page P. Thus, the friction member 329 can separate the first page P from the second and subsequent pages P during contact of the pages P with the page handling surface, and can prevent turning of the pages P in an overlapped state at once.

The page-lifting reduction device 30 also has the side fixing portions 315 and 316 for pushing the side of the opened book B at the original position. These side fixing portions reduce the misalignment of the book B and ensure a stable page-turning operation of the page-turning apparatus 1.

The page-lifting reduction device 30 includes the shafts 33 which guide the page fixing unit 32 in the direction of pushing the pages P at the original position and in the direction of releasing the pushing of the pages P, and the coil springs 34 which bias the page fixing unit 32 in the direction of pushing the pages P at the original position. Thus, the pages P at the original position can be readily pushed by the page fixing unit 32 through lifting and release of the page fixing unit 32.

The page-lifting reduction device 30 has the attachment (magnetic sheet) for detachably fixing the page-lifting reduction device 30 to the support base 20 (the first support plate 21). This configuration can fix the page-lifting reduction device 30 at a desired position of the support base 20 and can improve the usability of the page-lifting reduction device 30.

The present invention is not be limited to the aforementioned embodiment and may be appropriately modified.

In the above-described embodiment, the page fixing unit 32 of the page-lifting reduction device 30 pushes the fore edge side of the page P at the original position and handle the page and lower subsequent pages P. As shown in FIGS. 8A and 8B, a page fixing unit 132 may be provided for pushing the fore edge side and the top of the pages at the original position and handling the page and lower subsequent pages P.

In detail, the page fixing unit 132 has a right triangular shape in plan view and an L-shape in cross-sectional view. The page fixing unit 132 has an L-shaped bent portion having a curved (concave) surface (i.e., a page handling surface) which comes into contact with the edges of the stacked pages P at the original position. The page fixing unit 132 is slidably supported by a support 131 having an L-shape in plan view through sliding grooves 131a and 131b which are provided in the direction for pushing or releasing the pushing of the pages P at the original position. The pages P at the original position may be pushed by the weight of the page fixing unit 132 itself or the biasing force of a spring (not shown).

The page fixing unit 132 enables the stacked pages P to be handled along the page handling surface in cooperation with pushing of the pages P at the original position. The page fixing unit 132 can reduce attachment between the pages P or prevent adhesion between the ends of the pages P caused by burrs formed during page cutting, and thus can prevent turning of the pages in an overlapped state P at once.

In the above-described embodiment, the positioning of the page-lifting reduction device 30 fixed on the first support plate 21 requires temporary removal of the reducer 30 from the first support plate 21 and then relocation of the reducer 30 at a predetermined position, or requires manual sliding of the reducer 30 fixed on the first support plate 21 to a predetermined position. The first support plate 21, for example, may be provided with a base portion and a slide portion which can slide with respect to the base portion such which the page-lifting reduction device 30 can be detachably fixed to the slide portion. This configuration of the first support plate 21 facilitates the positioning of the page-lifting reduction device 30 and further improves the usability of the page-lifting reduction device 30.

The above-described embodiment should not be construed to limit the invention. The scope of the invention is defined by the following claims and equivalents thereof.

What is claimed is:

1. A page-lifting reduction device for reducing lifting of each of pages of an opened book, the page-lifting reduction device comprising:
a page fixing unit that pushes the pages; and
an adjusting unit that adjusts a position of the page fixing unit in a thickness direction of the book depending on a thickness of the book,
wherein the page fixing unit comprises a page handling portion to handle the pages while the pages are being pushed.

2. The page-lifting reduction device according to claim 1, wherein the page handling portion has a curved or inclined page handling surface which comes into contact with edges of the pages when handling the pages.

3. The page-lifting reduction device according to claim 2, wherein the page handling portion comprises a friction member disposed on the page handling surface, the friction member preventing slip of the pages.

4. The page-lifting reduction device according to claim 1, further comprising a side fixing portion to push at least one side of the opened book.

5. The page-lifting reduction device according to claim 4, wherein the side fixing portion pushes two orthogonal sides of the opened book.

6. The page-lifting reduction device according to claim 1, wherein the adjusting unit comprises a guide member that guides the page fixing unit in a direction of pushing of the pages and in a direction of releasing the pushing of the pages, and a biasing member that biases the page fixing unit in the direction of pushing of the pages.

7. The page-lifting reduction device according to claim 1, further comprising an attachment member that detachably fixes the page-lifting reduction device to a support base for supporting the opened book.

8. A page-lifting reduction device comprising:
a contact member that includes a first region which comes into contact with a page of an opened book and a second region which comes into contact with a side of the opened book; and
a pressing unit that causes the contact member to press the page and subsequent pages in a thickness direction of the opened book, wherein
the second region has a shape such that an edge of an upper page of the opened book is more displaced compared to a lower page toward a seam of the book, provided that an opened page is defined as an uppermost page.

9. A page-turning apparatus for turning each of pages of an opened book, the page-turning apparatus causing a predetermined unit to be brought into contact with a page of the opened book at an original position and to release the page from the predetermined unit at a turned position, the page following the predetermined unit to the turned position, the page-turning apparatus comprising:
a support base that supports the opened book; and
the page-lifting reduction device according to claim 1.

10. The page-turning apparatus according to claim 9, wherein the support base comprises a base portion and a slide portion which is slidable with respect to the base portion, and wherein the page-lifting reduction device is fixed to the slide portion.

11. A method of turning each of pages of an opened book, comprising:
handling the pages while pushing the pages with a page fixing unit which includes a curved or inclined page handling surface at an original position
causing a predetermined unit to be brought into contact with an upper page of the opened book at the original position; and
releasing the page from the predetermined unit at a turned position, the page following the predetermined unit to the turned position due to the contact.
